(19) United States
(12) Patent Application Publication
(10) Pub. No.: US 2017/0270459 A1
(43) Pub. Date: Sep. 21, 2017

(54) Device, System, and Method for Tracking Job Management

(71) Applicant: Cool Wind Ventilation Corp., Glendale, NY (US)

(72) Inventors: Dominic Grasso, Glendale, NY (US); David Sullivan, Glendale, NY (US); Linda Jennings, Glendale, NY (US); Joseph Marlin, Glendale, NY (US)

(21) Appl. No.: 15/070,489

(22) Filed: Mar. 15, 2016

(51) Int. Cl. G06Q 10/06; G06F 17/50

(52) U.S. Cl. CPC G06Q 10/063114; G06Q 10/06313; G06F 17/50

(57) ABSTRACT

A device, system, and method tracks a job management. The method performed by a central processing server includes receiving a layout drawing of an installation job, the layout drawing including a plurality of components to be installed at a work site. The method includes receiving status information of the components as a status of the components is updated. The method includes dynamically updating a current status for each of the components upon receiving the status information. The method includes receiving a request for a status update from a user device for a selected component of the components. The method includes determining the current status of the selected component. The method includes transmitting, by the server, the current status of the selected component to the user device.

### BACKGROUND INFORMATION

A job such as a construction job or the installation of complicated systems such as HVAC or electrical systems may require a plurality of people working cooperatively to complete the fabrication, delivery and installation of a wide variety of components. As the complexity of a job increases, the number of people and components and types of components often increase. However, the tracking of components in complex jobs has been difficult and has generally involved significant time lags making it difficult to effectively coordinate the various activities.

For example, people have generally manually tracked the progress in these jobs by making reports that are collated and updated, for example, at predetermined times (e.g., at the end of a shift). Even if these reports are computerized, the process is time consuming, the updates are not available during the day in which they are gathered and are often inaccurate and incomplete especially in more complicated jobs.

### SUMMARY OF THE INVENTION

The exemplary embodiments are directed to a method comprising: receiving, by a central processing server, a layout drawing of an installation job, the layout drawing including a plurality of components to be installed at a work site; receiving, by the server, status information of the components as a status of the components is updated; dynamically updating, by the server, a current status for each of the components upon receiving the status information; receiving, by the server, a request for a status update from a user device for a selected component of the components; determining, by the server, the current status of the selected component; and transmitting, by the server, the current status of the selected component to the user device.

The exemplary embodiments are directed to a central processing server comprising: a transceiver receiving a layout drawing of an installation job, the layout drawing including a plurality of components to be installed at a work site and status information of the components as a status of the components is updated; and a processor dynamically updating a current status for each of the components upon receiving the status information, the processor determining the current status of the selected component for a request of a status update from a user device for a selected component of the components, wherein the transceiver transmits the current status of the selected component to the user device.

The exemplary embodiments are directed to an executive device comprising: a transceiver transmitting a request for status updates of components associated with a first layout drawing, the request including a first identification of a first job among a plurality of jobs and a second identification of a first layout drawing among a plurality of layout drawings, the transceiver receiving a response including the status updates of the components; a processor generating a visual representation including visual features indicating an installation time for each of the components based on the status updates, the visual representation further including a drawing key defining the visual features; and a display device showing the visual representation.

### BRIEF DESCRIPTION OF THE DRAWINGS

FIG. 1 shows a system for tracking a job management operation according to the exemplary embodiments.

FIG. 2 shows a server of the system of FIG. 1 according to the exemplary embodiments.

FIG. 3 shows an electronic device corresponding to components of the system of FIG. 1 according to the exemplary embodiments.

FIG. 4 shows a method for tracking a fabrication of components according to the exemplary embodiments.

FIG. 5 shows a method for tracking a receiving of vendor components according to the exemplary embodiments.

FIG. 6 shows a method for tracking available components to be shipped according to the exemplary embodiments.

FIG. 7 shows a method for tracking components that have shipped according to the exemplary embodiments.

FIG. 8 shows a method for tracking components that have been installed according to the exemplary embodiments.

FIG. 9 shows a method for updating a layout drawing including components according to the exemplary embodiments.

FIG. 10 shows a method for displaying drawings of components according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method for tracking job management using a real-time status representation. Specifically, the exemplary embodiments provide a mechanism whereby the status of a job component is updated in real time whenever a change to the status has occurred. The status of the component may change as the component is tracked through a plurality of stages such as an availability stage, a shipping stage, and an installation stage. The exemplary embodiments enable the tracking of the component as the component passes through these various stages as well as the tracking of the status of the component through time relative to the progress of the job itself and other components in the job. Accordingly, the exemplary embodiments may further generate a visual or other representation indicating a current status of each component within a layout associated with the job.

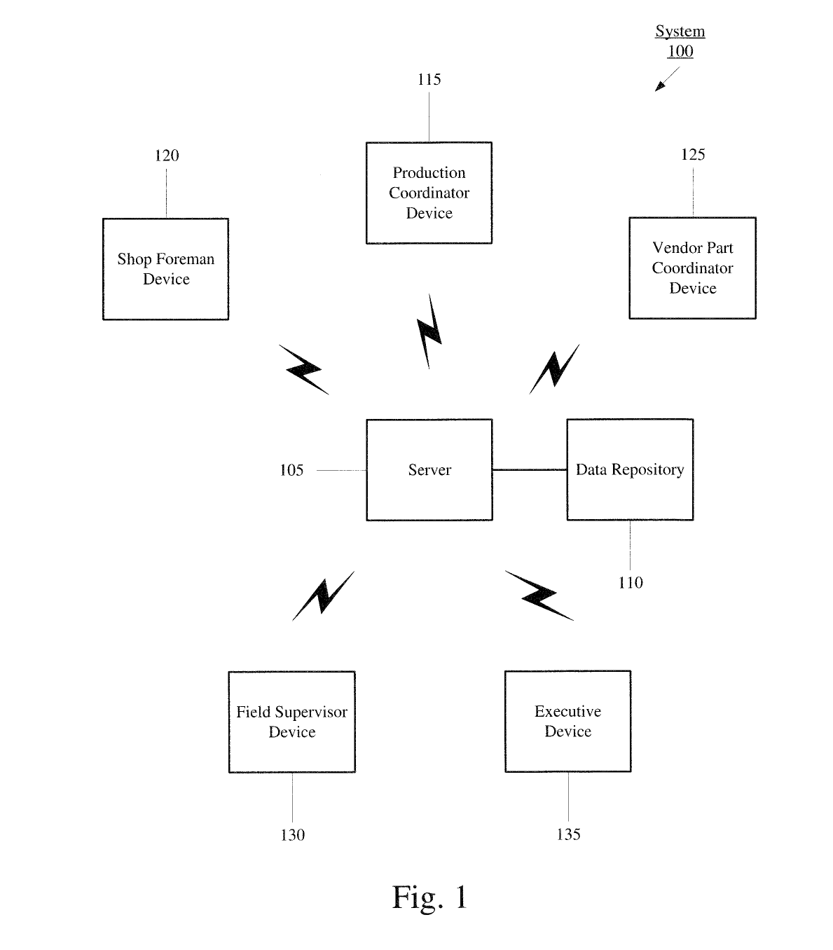

FIG. 1 shows a system 100 for tracking a job management operation according to the exemplary embodiments. The system 100 may include a plurality of components including a server 105, a data repository 110, a production coordinator device 115, a shop foreman device 120, a vendor part coordinator device 125, a field supervisor device 130, and an executive device 135. As will be described in further detail below, the server 105 and the data repository 110 may provide a central processing portion of the system 100 to synchronize information shared between the other devices 115-135. The production coordinator device 115, the shop foreman device 120, the vendor part coordinator device 125, and the field supervisor device 130 may provide information with regard to the status of components to be installed during the job. The executive device 135 may be used to display requested information regarding the status of a group of components associated with a layout drawing for the job.

The system 100 is illustrated including a server 105 having a wired connection to the data repository 110. Accordingly, the data repository 110 may be located in a location substantially similar to the location of the server 105. However, it should be noted that the server 105 may utilize a wireless connection to communicate with the data repository 110. Accordingly, the data repository 110 may be a remote component and the server 105 and the data repository 110 may communicate utilizing any wired or wireless network connection such as, for example, the Internet or telecommunications networks.

The server 105 may also utilize a network connection via the communications network for the other devices 115-135. Accordingly, the devices 115-135 may each establish a connection to the communications network via a wired or wireless connection for data exchange with the server 105. As will be described below, the devices 115-135 may be located remotely from the server 105 with the server 105 at, for example, an office of the company performing the job while the devices 115 may be at one or more sites at which different phases of the job are being performed (e.g., a factory where components to be installed are fabricated, a receiving area at which the components are delivered to a job site and at various locations at the job site where the components are to be installed). It should be noted that the communications network may include one or more communications networks interconnected with one another for the connection to be established between the devices 115-135 with the server 105. For example, the server 105 may be connected to a private network which is connected to the Internet. The production coordinator device 115 may be connected to a WiFi network which is also connected to the Internet. In this manner, through multiple communications networks, the production coordinator device 115 may establish a connection to the server 105.

The server 105 and the data repository 110 may represent any central processing component of the system 100 that exchanges data with the devices 115-135 to synchronize the information associated with the job. The data repository 110 may provide a storage functionality for the layout drawings, the status information for the components in the layout drawings (e.g., the components of various systems to be installed at the job site), component information for the components in the layout drawings, etc. In a first exemplary functionality and as will be described in further detail below, the server 105 may exchange the data to maintain and update information concerning the status of components in a layout drawing. The layout drawing may represent, for example, a schematic such as a computer aided design (CAD) drawing, showing a design for one or more systems to be installed. Accordingly, the layout drawing may illustrate a plurality of components and how these components are to be installed and connected to one another. The layout drawing may have been created, for example, by a draftsman based on information provided by, for example, an engineer or designer. A job may be represented on a plurality of layout drawings each representing all or a portion of a space in which components are to be installed. For example, a separate drawing may be provided for different locations of a job site (e.g., each floor of a building in which the job extends over multiple stories) with all components of all of the systems to be installed in a particular location represented on a single drawing or with separate drawings for each system or for a subset of systems on each floor. The system may also handle drawings for multiple jobs. The server 105 maintains information for all of the layout drawings associated with a given job or for a plurality of jobs. Furthermore, as would be understood by those skilled in the art, each component in the drawings may be identified by a unique number or series of symbols (unique identifier) which may later be coordinated with manufacturer part numbers, etc. This unique identifier may be different even for each instance of a part for which multiple copies are to be installed. This can help to eliminate mistakes or confusion that might result from the use of a single identifier to represent multiple copies of the same item. However, those skilled in the art will understand that identical items may be represented by the same identifier. These identifiers may be set by the designer or engineer who creates the drawings or by a production coordinator, vendor coordinator or other user of the system and added to the drawings as will be understood by those skilled in the art.

In a second exemplary functionality and as will be described in further detail below, the server 105 receives a request to view the status of components in a selected layout drawing. As current status information is being exchanged between the server 105 and the devices 115-130, the server 105 generates a near-live status indication for components of the selected layout drawing indicating updated status of all of the represented components with information on installation timing, indications of associated component information, etc. That is, the exemplary embodiments provide a mechanism whereby a user is provided real-time status information of a component in a layout drawing. In this manner, the user proceeds accordingly such as determining an ensuing step to be performed toward completion of the job.

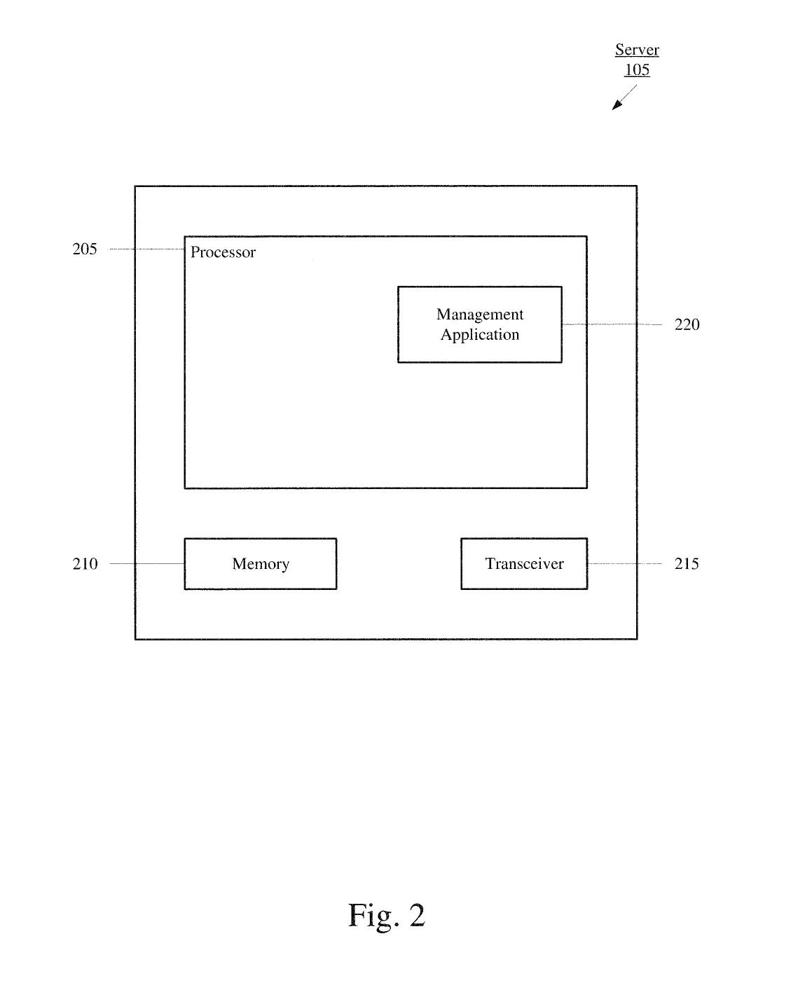

FIG. 2 shows exemplary components of the server 105 of the system 100 of FIG. 1 according to the exemplary embodiments. The exemplary server 105 includes a processor 205, a memory 210, and a transceiver 215. As would be understood by those skilled in the art, the processor 205 performs conventional functionalities such as, for example, data processing functionalities via a management application 220. The memory 210 performs data storage functionalities (e.g., storing data associated with the processes performed by the processor 205 and data associated with components, layout drawings, and component status) and the transceiver 215 represents any input/output component that performs functionalities associated therewith. For example, the transceiver 215 may be used for data exchange functionalities. The transceiver 215 is illustrated in the system 100 of FIG. 1 as capable of wired and wireless communications.

With regard to the processing functionalities of the server 105, as indicated above, the processor 205 may be configured to execute the management application 220 to, for example, maintain and update information relating to the components in layout drawings. Accordingly, the management application 220 may operate in an automated manner updating layout drawings as soon as updates are received from the devices 115-130, at predetermined times or upon requests (e.g., from a system administrator or from any user of the system 100). The management application 220 therefore includes a retrieval operation in which status update requests are handled upon receipt and an automated task operation in which the visual representations are maintained and updated for retrieval upon request from the executive device 135 (e.g., in a summary view).

As noted above, any or all of the production coordinator device 115, the shop foreman device 120, the vendor part coordinator device 125, and the field supervisor device 130 may be mobile devices located at any given time at different places associated with a job to provide information relating to components in a layout drawing and the status of these items. Specifically, the production coordinator device 115 may be utilized by a production coordinator who determines which components will be fabricated and when (e.g., at a factory). Therefore, objects may be fabricated and ready when needed allowing the fabrication schedule to be optimized in coordination with the current status of the installation of components as well as other factors such as available storage space at the installation location, etc. The shop foreman device 120 may be utilized by a shop foreman who manages the fabrication of the components as well as the shipping of components to job sites. The vendor part coordinator device 125 may be utilized by a vendor part coordinator who determines components in the layout drawing to be purchased and received from a vendor. The vendor part coordinator may also manage receipt of components from vendors. The field supervisor device 130 may be utilized by a field supervisor who manages the installation of the components as indicated in the layout drawing. As the devices 115-130 are utilized by different types of people working on the job, the devices 115-130 may accordingly be located at various different locations. Specifically, the production coordinator device 115 may be located at the production facility. The shop foreman device 120 may also be located at the production facility and/or a shipping facility. The vendor part coordinator device 125 may also be located at the production facility and/or the shipping facility. The field supervisor device 130 may be located at the job site corresponding to the layout drawing and any of these components may be mobile so that its location may be mobile permitting any of these users to update information from any location (e.g., while traveling between job sites or from an office to a job site or production facility, etc.).

It should be noted that the system 100 including a single one of each of the devices 115-130 is only an exemplary embodiment. Those skilled in the art will understand that a job may utilize any number of production coordinators, vendor part coordinators, shop foremen, and/or field supervisors. As a job becomes more complex and with different capabilities and limitations at various locations, the number of people working on the job in any or all of these categories may also increase. For example, a first production facility may be tasked with manufacturing a first component while a second component is to be fabricated at a second production facility with each production facility including a respective shop foreman and/or production coordinator although a single production coordinator may be responsible for both production facilities.

As noted above, the executive device 135 may be used to display requested information regarding the status of all or any subset of components associated with a layout drawing for the job. The executive device 135 may be utilized by an executive, an administrator, an overseer, etc. (hereinafter collectively referred to as “executive”) who wishes to view the progress of the job pertaining to any selected layout drawing(s) associated with the job. Specifically, the executive may view the progress of the job in a summary review (e.g., progress accomplished for the job from a previous business day to a current business day). Accordingly, the executive may transmit requests to the server 105 and receive visual representations of the requested layout drawing showing the most updated status and/or representations of the changes in status over time. As the executive may be located in any location, the executive device 135 is not required to be limited to being at any particular location and may be local or remote relative to the server 105 and may be a mobile device.

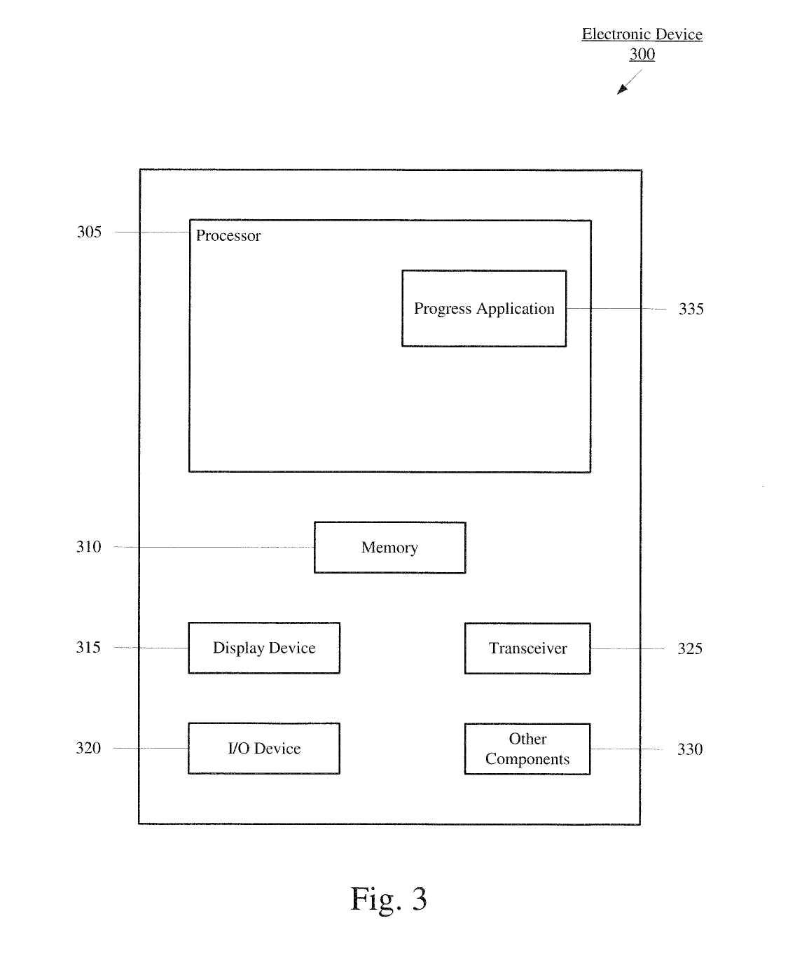

FIG. 3 shows exemplary components of an electronic device 300 corresponding to the devices 115-135 of the system 100 of FIG. 1 according to the exemplary embodiments. The electronic device 300 may represent any electronic device configured to perform the progress management functionalities associated with a progress application. As each of the devices 115-135 may utilize the progress management functionality, the electronic device 300 may therefore represent any of the devices 115-135. The electronic device 300 may be a portable device such as a personal mobile phone, a work issued mobile phone, a tablet computer, a laptop computer, a wearable, etc. The electronic device 300 may also be a client stationary device such as a desktop terminal. The electronic device 300 may include a processor 305, a memory 310, a display device 315, an input/output (I/O) device 320, a transceiver 325, and other components 330. The other components 330 may include, for example, an audio input device, an audio output device, a battery, a data acquisition device, ports to electrically connect the UE 200 to other electronic devices, etc.

The processor 305, the memory 310, and the transceiver 325 may perform functionalities substantially similar to those described above in regard to the processor 205, the memory 210, and the transceiver 215 of the server 105. The display device 315 may be a hardware component configured to show data to a user while the I/O device 320 may be a hardware component that enables the user to input data. For example, the executive device 135 may receive a selected layout drawing from a menu of available layout drawings via the I/O device 320. A request may be packaged and transmitted via the transceiver 325 to receive a visual representation of the layout drawing with component information included. The visual representation may be shown on the display device 315. In another example, the production coordinator device 115 may retrieve a layout drawing on the display device 315 showing the current state of a job (e.g., which parts have been installed, which have been manufactured and are already on site, which have been manufactured and have not yet been delivered, which parts are likely to be installed during an upcoming time frame, etc.) so that the production coordinator may select a set of already manufactured components to be delivered to the job site and/or to set a schedule for the manufacture of components that will soon be needed. That is, the production coordinator can use the updated information about the current status of the job site to make decisions about delivery and fabrication that enable a more efficient and timely delivery of the parts that are actually needed as the need for these parts arises without cluttering up the job site and/or the production facility with parts for which the people doing ₜhe installation are not prepared.

With regard to the processing functionality performed by the processor 305 of the electronic device 300, the processor 305 may execute a progress application 335. The progress application 335 may represent an application that may be used by any person associated with any of the devices 115-135. However, the progress application 335 providing the functionality for all of these people is only exemplary and each of the devices 115-135 may include a respective application to perform the particular functionality corresponding to the particular user's job. For exemplary purposes, the progress application 335 is described as including each of the functionalities.

The functionalities provided by the progress application 335 may relate to the different status updates of components in the layout drawing as well as providing visual representation of the layout drawing. For the proper functionality to be utilized, the user may initially enter login information or identification information that determines the type of position the user has for a particular job. Therefore, the proper functionality may be automatically selected and appropriate user interfaces may then be provided. However, it should be noted that the functionality of the progress application 335 may be manually selected by the user.

A first example will describe use of the progress application 335 by a production coordinator utilizing the production coordinator device 115. When the progress application 335 provides the functionality corresponding to the production coordinator, the progress application 335 displays a layout drawing selected by the user. The progress application 335 may enable the production coordinator to receive one or more inputs of components to be fabricated next to create a list of corresponding components. In another example, the progress application 335 may provide a user interface that enables the production coordinator to view selected components in the layout drawing relevant to his decision-making as to which parts are to be fabricated next, which are to be delivered, etc. The progress application 335 may receive or generate the unique identification number for each component which number may then be used to track the status of each component as that component passes through the various stages of its progress through the system (e.g., not yet manufactured, manufactured, delivered to the job site, installed, installation inspected, etc.).

In a second example, the progress application 335 is used by a shop foreman utilizing the shop foreman device 120. When the progress application 335 provides the functionality corresponding to the shop foreman, the progress application 335 displays a list of components from the layout drawing selected by the production coordinator. The shop foreman may thereby manage the fabrication of the selected components on the factory floor. The progress application 335 provides a user interface enabling the shop foreman to identify components that have been fabricated and are ready for shipping to the appropriate work site so that their status can be immediately updated. When the shop foreman is also responsible for the shipping of the components, the progress application 335 may also display a list of the components (e.g., both fabricated and received from vendors) ready to be shipped to the job site.

In a third example, the progress application 335 is used by the vendor part coordinator utilizing the vendor part coordinator device 125. When the progress application 335 provides the functionality corresponding to the vendor part coordinator, the progress application 335 performs select functionalities substantially similar to those provided to the production coordinator and the shop foreman. Specifically, the progress application 335 displays a selected layout drawing with a user interface enabling the vendor part coordinator to review the status of all of the components relevant to him in making a shipping schedule so that he can coordinate the delivery of parts so that the job can proceed as efficiently as possible. Since the vendor part coordinator also manages the receiving of the components, the progress application 335 may display a list of the components to be received from the vendors as well as the time required for delivery, etc. so that the vendor part coordinator can ensure that the parts needed by installers are there when needed without cluttering the job site or a storage area with parts that are not yet needed.

In a fourth example, the progress application 335 is used by a field supervisor utilizing the field supervisor device 130. When the progress application 335 provides the functionality corresponding to the field supervisor, the progress application 335 displays a list of components from the layout drawing that have been shipped to the work site where the field supervisor is assigned while also indicating which parts have already been installed. The field supervisor may thereby manage a schedule for the installation of selected components and will update the status of components that have arrived at the job site as well as components that have been installed. The field supervisor may optionally update the status of certain parts that have been received at the job site to indicate that installation is imminent and even to create a list of components that have not yet been received but will soon be required. This allows the production coordinator, vendor part coordinator and/or the shop foremen to manage shipping and fabrication to enable installation to proceed smoothly.

In a fifth example, the progress application 335 is used by an executive utilizing the executive device 135. When the progress application 335 provides the functionality corresponding to the executive, the progress application 335 may display, for example, a menu of layout drawings for the executive to select. When the executive has provided an input selecting a layout drawing from the menu, the progress application 335 may perform communication operations and generate a visual representation for the selected layout drawing including updated status for all or any selected subset of components illustrated on the particular drawing. This enables the executive to monitor the status of all the phases of the job including all of the updates received from all of the other users of the system. The executive may also be provided summary reports of progress in a variety of manners such as showing all installation activity history or all activity history from a first time to a second time that follows the first time. As will be described in detail below, the visual representation may illustrate the components represented by indications of installation date.

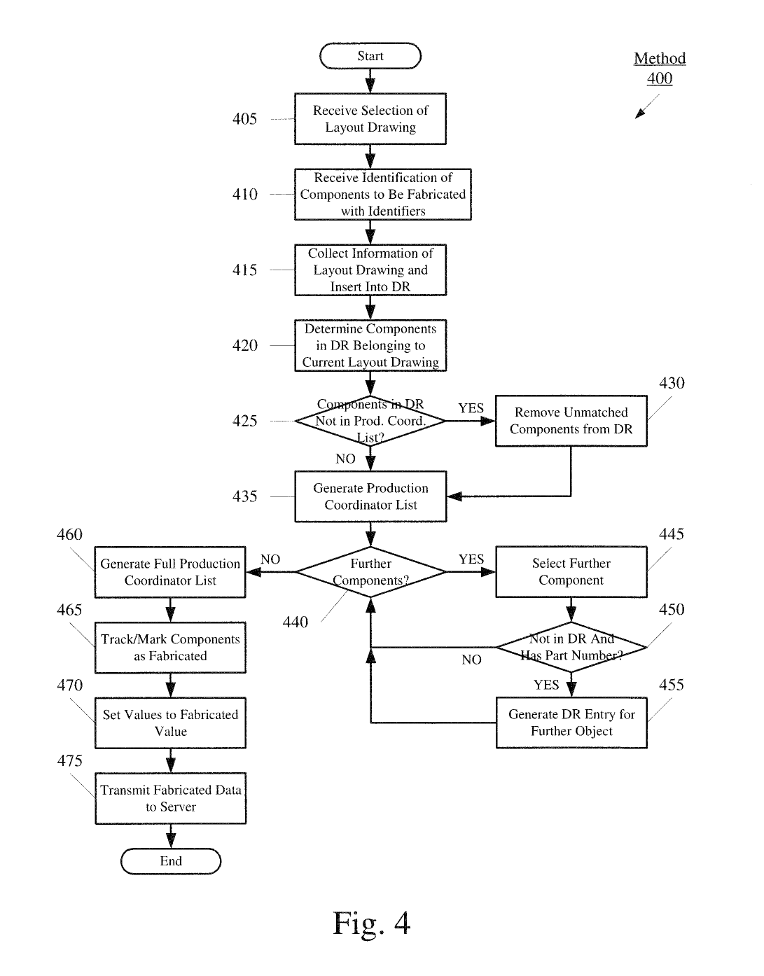

FIG. 4 shows a method 400 for tracking the fabrication of components according to the exemplary embodiments. The method 400 of this embodiment relates particularly to the progress application 335 permitting the production coordinator and/or shop foreman to interact with the system using the production coordinator device 115 and/or the shop foreman device 120. As will be described further below, the method 400 incorporates interaction between the production coordinator device 115 and the server 105 to manage and track the status of components to be fabricated, for example, in a layout drawing. The method 400 will be described with regard to the system 100 of FIG. 1.

In step 405, the production coordinator device 115 receives input from the production coordinator selecting a layout drawing. As described above, the progress application 335 may receive manual input indicative of the layout drawing. In another exemplary embodiment, the progress application 335 may provide an interface such as a menu or list from which layout drawings associated with one or more jobs may be selected. The production coordinator may also load a layout drawing to be used. The progress application 335 provides a user interface for the layout drawing enabling the production coordinator to provide input to update the status of components and/or to add notes or comments related to any component or to any subset of components that are to be fabricated. In step 410, the production coordinator identifies components to be fabricated and inputs to device 115 a unique identifying number for each component to be fabricated that is represented in the selected layout drawing. Specifically, the production coordinator indicates components selected for fabrication by, for example, supplying a unique identifier number for each of these parts, by interacting with the parts as represented in the selected layout drawing, etc.

In step 415, the production coordinator device 115 collects information from the layout drawing and inserts the information into the data repository 110. The progress application 335 may analyze the layout drawing to identify all components included in the layout drawing. Thus, in step 420, the production coordinator device 115 identifies the components in the data repository 110 that belong to the current layout drawing. In step 425, the production coordinator device 115 determines whether there are any components in the data repository 110 that are not in the layout drawing. If such superfluous components exist, in step 430, the production coordinator device 115 removes the unmatched components from a production coordinator list in the data repository 110. In step 435, the production coordinator device 115 generates the production coordinator list including all components in the layout drawing that are to be fabricated.

In step 440, the production coordinator device 115 determines whether there are any further components in the collection to be added to the production coordinator list (e.g., for a production coordinator manufacturing ducts, are there any duct items left in the drawing that have not yet been added to this production coordinator list). Specifically, the production coordinator device 115 determines whether any components identified in the layout drawing have not been entered in the production coordinator list. If there is at least one further component identified in step 440, the production coordinator device 115 continues the method 400 to step 445. In step 445, the production coordinator device 115 selects any such further component. In step 450, the production coordinator device 115 determines whether this further component is not already in the production coordinator list stored in the data repository 110 and whether this component has an identifier (as entered by the production coordinator). If both of these conditions are not present for the further component, the production coordinator device 115 returns the method 400 to step 440 as the further component may relate to a yet pending component. If both of these conditions are present for the further component, the production coordinator device 115 continues the method 400 to step 455. In step 455, the production coordinator device 115 generates an entry in the production coordinator list for the further component based on the identifier assigned to the further component by the production coordinator. This process continues until all further components determined in step 440 have been identified and added to the production coordinator list.

Returning to step 440, when there are no further components, the production coordinator device 115 continues the method 400 to step 460. In step 460, the production coordinator device 115 generates the full production coordinator list including all of the components in the layout drawing to be fabricated (at least those to be fabricated under the control of this particular production coordinator). This production coordinator list is then provided to the server 105 so that the data may be forwarded to the shop foreman device 120.

In step 465, the shop foreman device 120 receives the production coordinator list enabling the shop foreman to track and mark the components as they are being fabricated. In step 470, the shop foreman device 120 sets values for the fabricated components identifying their current status (e.g., in process of being fabricated, fabricated, shipped, etc.). In step 475, the shop foreman device 120 transmits this data to the server 105 which updates the data repository 110 and updates the relevant layout drawings to reflect the current status of the components.

It should be noted that the method 400 represents an ongoing process and all components identified are not required to be fabricated simultaneously and in parallel. In contrast, the production facility has limited resources (e.g., machinery and/or people) that need to be utilized in a time and resource efficient manner. Accordingly, the method 400 may be continuously performed so that the production and storage facilities may be operated in the most efficient manner possible while supplying the components needed at the job site in a timely manner.

It should also be noted that the method 400 enables tracking of the location of fabricated components. When the server 105 has been provided with the information that a particular component (or components) has been fabricated, the server 105 may respond to requests for status updates for any components with a message or may display the components and their status in the corresponding layout drawings. For example, a request for the status of a component may return a response that the component has or has not yet been fabricated or may indicate the location of the component (i.e., at fabrication facility, in transit, delivered to job site, etc.). In this manner, the current status of all components may be updated in real time and may be provided to users immediately, on a predetermined schedule or as requested.

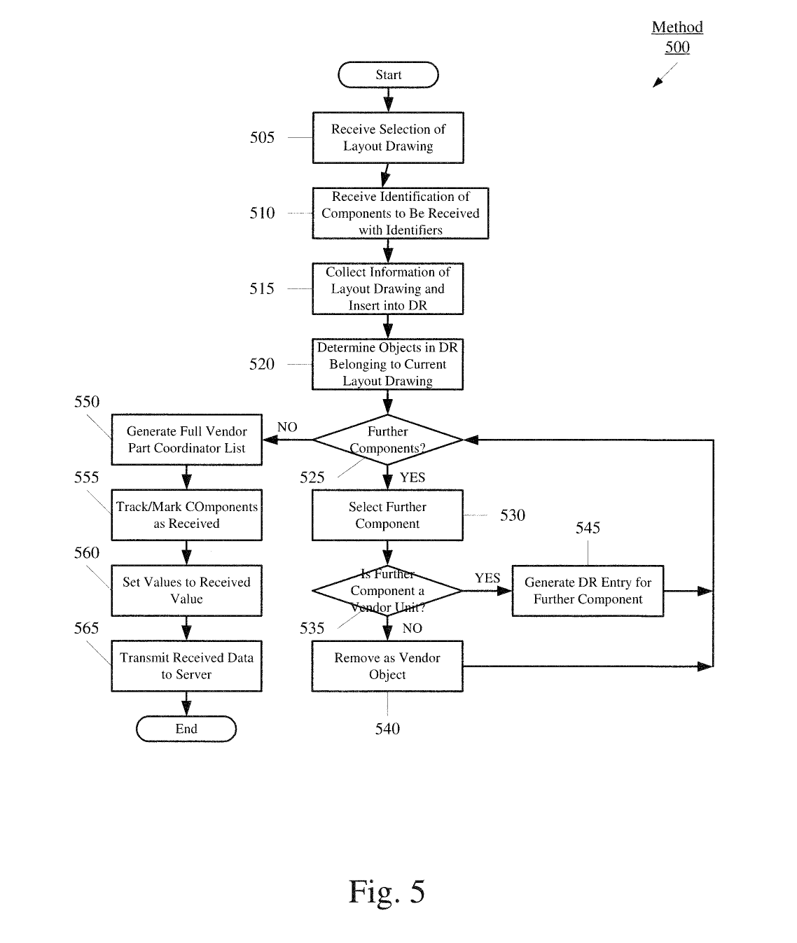

FIG. 5 shows a method 500 for tracking the receipt of vendor components according to the exemplary embodiments. The method 500 of this embodiment relates particularly to the progress application 335 providing permitting the vendor part coordinator to use the vendor part coordinator device 125. As will be described further below, the method 500 incorporates interaction between the vendor part coordinator device 125 and the server 105 to manage and track components in a layout drawing that are to be received from one or more vendors. The method 500 will be described with regard to the system 100 of FIG. 1.

In step 505, the vendor part coordinator device 125 receives from the vendor part coordinator a selection of a layout drawing. As described above, the progress application 335 may receive manual input indicative of the layout drawing. In another example, the progress application may provide an interface such as a menu or list in which layout drawings associated with one or more jobs may be selected. In a further example, the progress application 335 may run a command on the CAD drawing file for the selection. The vendor part coordinator may also load a layout drawing to be used. The progress application 335 may provide a user interface for the layout drawing enabling the vendor part coordinator to provide inputs to update the status of components and/or to add notes or comments related to any component or to any subset of components that are received from vendors. In step 510, the vendor part coordinator identifies components to be received from vendors and inputs to device 125 a unique identifying number for each component to be received from a vendor that is represented in the selected layout drawing. The unique identifying number may be substantially similar to the unique identifying number used by the production coordinator.

In step 515, the vendor part coordinator device 125 collects information from the layout drawing and inserts the information into the data repository 110. The progress application 335 analyzes the layout drawing to identify all components included in the layout drawing. Thus, in step 520, the vendor part coordinator device 125 identifies components in the data repository that belong to the current layout drawing. It is noted that the vendor part coordinator device 125 may only identify components in the data repository to be received from a particular vendor or group of vendors.

In step 525, the vendor part coordinator device 125 determines whether there are any further components in the collection to be added to a vendor part coordinator list (e.g., for a vendor part coordinator receiving ducts, are there any duct items to be received from vendors left in the drawing that have not yet been added to this production coordinator list). Specifically, the vendor part coordinator device 125 determines whether any components identified in the layout drawing remain that have not yet been entered in the vendor part coordinator list. If further components exist, in step 530, the vendor part coordinator device 125 selects such a further component. In step 535, the vendor part coordinator device 125 determines whether the further component is a vendor unit. Accordingly, if any remaining component is identified as not being a vendor component, in step 540, the unprocessed component is removed from the vendor coordinator list. An indication may be provided that may be forwarded to, for example, the production coordinator to have the component fabricated instead. However, if the further component is a vendor component (with an identifier from the vendor part coordinator), in step 545, the vendor part coordinator device 125 generates an entry in the vendor part coordinator list for the further component based on the identifier assigned to the further component by the vendor part coordinator. This process continues until all further components determined in step 440 have been identified and added to the vendor part coordinator list.

Returning to step 525, when there are no further components, the vendor part coordinator device 125 continues the method 500 to step 550. In step 550, the vendor part coordinator device 125 generates the full vendor part coordinator list including all of the components in the layout drawing to be received from vendors (at least those to be received from vendors under the control of this particular vendor part coordinator). In step 555, the vendor part coordinator device 125 tracks and marks the components as they are received from vendors. In step 560, the vendor part coordinator device 125 sets values for the received components appropriate to identify their current status. In step 565, the vendor part coordinator device 125 transmits this data to the server 105 which updates the data repository 110 and updates the relevant layout drawings to reflect the current status of the components.

It should be noted that the method 500 also represents an ongoing process and all components identified are not required to be received simultaneously. In contrast, vendors may provide components at different times and the method 500 may be continuously or intermittently performed as components in the layout drawing are received from vendors.

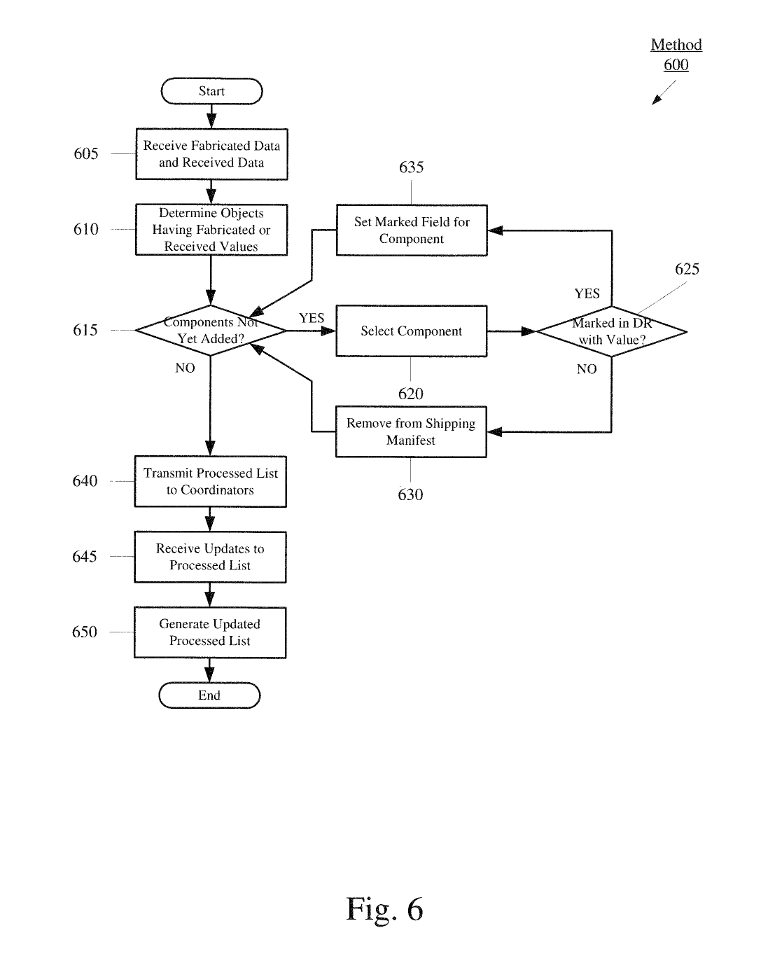

FIG. 6 shows a method 600 for tracking available components to be shipped according to the exemplary embodiments. The method 600 in this exemplary embodiment relates particularly to the management application 220 of the server 105. Accordingly, the method 600 will be described with respect to the server 105. As will be described further below, the method 600 describes interaction between the production coordinator device 115, the shop foreman device 120, and the vendor part coordinator device 125 with the server 105 to manage and track those components available to be shipped that are represented in a layout drawing. The method 600 will be described with regard to the system 100 of FIG. 1.

In step 605, the server 105 receives the data identifying fabricated components from the shop foreman device 120 and data identifying components received from vendors from the vendor part coordinator 125. As discussed above, the fabricated data and the received data may be received from the respective devices when the progress application on each device has verified which components have been properly fabricated or received. Furthermore, as the exemplary embodiments provide a near-live visual representation, the server 105 may receive the fabricated data and/or the received data whenever the respective device has determined a change to a status.

In step 610, the server 105 identifies components that have values indicating that they have been “marked fabricated” or “marked received.” Components having one of these values are considered available to ship. For components that have already been shipped, this value has been changed so that these components are not considered in this process. It is noted that the value determined for the method 600 may be an initial value as the availability of the component represents a first status analysis which is altered as the component status changes (e.g., when the component is shipped, received or installed).

In step 615, the server 105 determines whether the fabricated data and/or the received data identify components that have not yet been added to a shipping manifest. Those skilled in the art will understand that the data repository 110 may use any number of methods to ensure that component's status values are properly understood by the server 105. For example, if a component has been installed, depending on the manner in which component status is represented in the data repository 110, this component may no longer include a data entry reading “shipped.” However, through a method in which different status indicators may represent a temporal scheme, the system will know that any component that has the status “installed” should not be included in a list of components needing to be shipped currently even if the status no longer indicates “shipped.” Those skilled in the art will understand that there are many means to achieve this clarity. The components identified by method 600 may include, for example, components previously fabricated or which have already been received but which have not yet been shipped. As the method 600 relates to a continuous operation in completing the job, there may be components that were fabricated/received in a prior passthrough of the previous methods. For example, in a first passthrough for a given job, no components may have been identified as ready to ship. However, in a second or further passthrough for the job, there may be one or more components that were fabricated/received and are ready to ship. Each time the status of various components is updated, the method 600 will update the list and remove any items that have been shipped.

If at least one component ready for shipping is identified, the server 105 continues the method 600 to step 620. In step 620, the server 105 selects this component and in step 625, the server 105 determines whether the selected component has a relevant value or mark (e.g., “marked fabricated” or “marked received”) with the appropriate user role in the data repository 110. If the selected component does not have the value/mark and the user role, the server 105 continues the method 600 to step 630 where a determination is made that the component is either not yet fabricated or received or has already been shipped. Accordingly, the component may be removed from a shipping manifest. However, if the selected component has the proper value/mark and the user role, the server 105 continues the method 600 to step 635 where the marked field for the component is set.

Returning to step 615, when there are no further components to analyze, the server 105 continues the method 600 to step 640. In step 640, the server 105 generates a processed list (ready for shipping) that is transmitted to the production coordinator device 115, the shop foreman device 120, and/or the vendor part coordinator device 125. When the devices 115-125 receive the processed list, the progress application 335 displays the processed list to the production coordinator, shop foreman, or vendor part coordinator. This provides an opportunity to update the status for any components that require a change. For example, the production coordinator may determine that a further component may have been fabricated or that a fabricated component may have been improperly manufactured. The production coordinator may thereby update items on the processed list if required. Thus, in step 645, the server 105 receives the updates to the processed list. Accordingly, in step 650, the server 105 generates the updated processed list.

The shop foreman or another user may then place the components on the processed list on vehicles for shipping to the job site. The shop foreman may track/mark the components as they are shipped and update their status accordingly. For example, components that have been shipped may have values set corresponding to “marked shipped.”

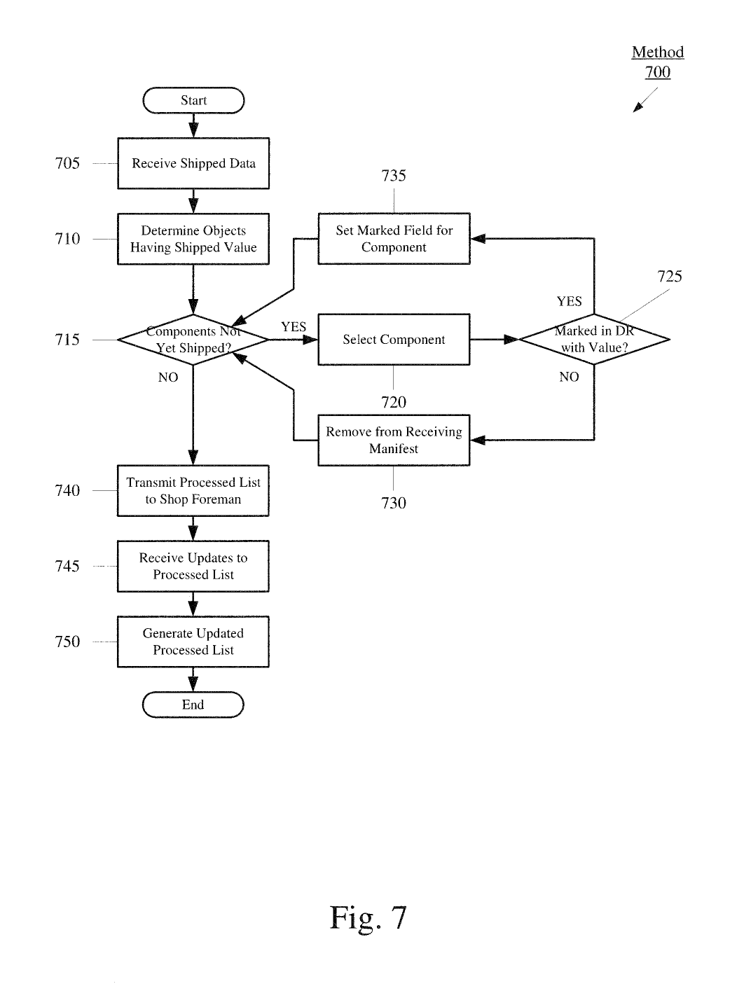

FIG. 7 shows a method 700 for tracking components that have shipped according to the exemplary embodiments. The method 700 in this exemplary embodiment relates particularly to the management application 220 of the server 105. Accordingly, the method 700 will be described with respect to the server 105. As will be described further below, the method 700 describes an interaction between the shop foreman device 120 and the field supervisor device 130 with the server 105 to manage and track components in a layout drawing that have shipped. The method 700 will be described with regard to the system 100 of FIG. 1.

In step 705, the server 105 receives from the shop foreman device 120 data corresponding to the components that have shipped. As discussed above, the shipped data may be received from the shop foreman device 120 once the progress application 335 has verified which components have been shipped. Furthermore, as the exemplary embodiments provide a near-live visual representation, the server 105 may receive the shipped data each time the shop foreman device 120 indicates that a component has been shipped, at predetermined time intervals or when updated status requested by any user.

In step 710, the server 105 identifies components that have values corresponding to “marked shipped.” Components having this value are considered to have shipped and are in transit to the appropriate job site. For components that have already been received at the job site or installed, this value is changed so that these components are not considered in this process. However, this is only exemplary and the components that have already shipped and been received or installed may maintain the shipped, received, or installed value to indicate the status at all times. It is noted that the value determined for the method 700 may be a next role value as the location of the component represents a second status analysis which is altered as the component status changes.

In step 715, the server 105 determines whether the shipped data identify any components that have not yet been shipped although on a shipping manifest. It is again noted that any number of methods may be used to ensure the component's status values are properly understood by the server. As the method 700 relates to a continuous operation in completing the job, there may be components that were prepared for shipping and entered on the shipping manifest in a prior passthrough of the previous methods. Each time the status of various components is updated, the method 700 will update the list and remove any items that have been shipped.

If at least one component ready for shipping is identified, the server 105 continues the method 700 to step 720. In step 720, the server 105 selects this component and in step 725, the server 105 determines whether the selected component has a relevant value or mark (e.g., “marked shipped”) with the appropriate user role in the data repository 110. If the selected component does not have the value/mark and the user role, the server 105 continues the method 700 to step 730 where a determination is made that the component is either not yet fabricated or received or has already been shipped. Accordingly, the component may be removed from a receiving manifest at a job site. However, if the selected component has the proper value/mark and the user role, the server 105 continues the method 700 to step 735 where the marked field for the component is set.

Returning to step 715, when there are no further components to analyze, the server 105 continues the method 700 to step 740. In step 740, the server 105 generates a processed list (ready for shipping) that is transmitted to the shop foreman device 120. When the shop foreman device 120 receives the processed list, the progress application 335 displays the processed list to the shop foreman. This provides an opportunity to update the status for any components that require a change. For example, the shop foreman may determine that a further component may have been improperly manufactured and should not be shipped until a replacement component has been received. The shop foreman may thereby update items on the processed list if required. Thus, in step 745, the server 105 receives the updates to the processed list. Accordingly, in step 750, the server 105 generates the updated processed list.

The shop foreman may then provide the updated processed list to the server 105 to be received by field supervisors at the job site to which the components correspond. The field supervisors may track/mark the components as they arrive at the job site and update their status accordingly. For example, components that have been received at the job site may have values set corresponding to “marked received at job site.” The field supervisor may also track the components as they are installed by field mechanics. The components that have been installed may have values set corresponding to “marked installed.”

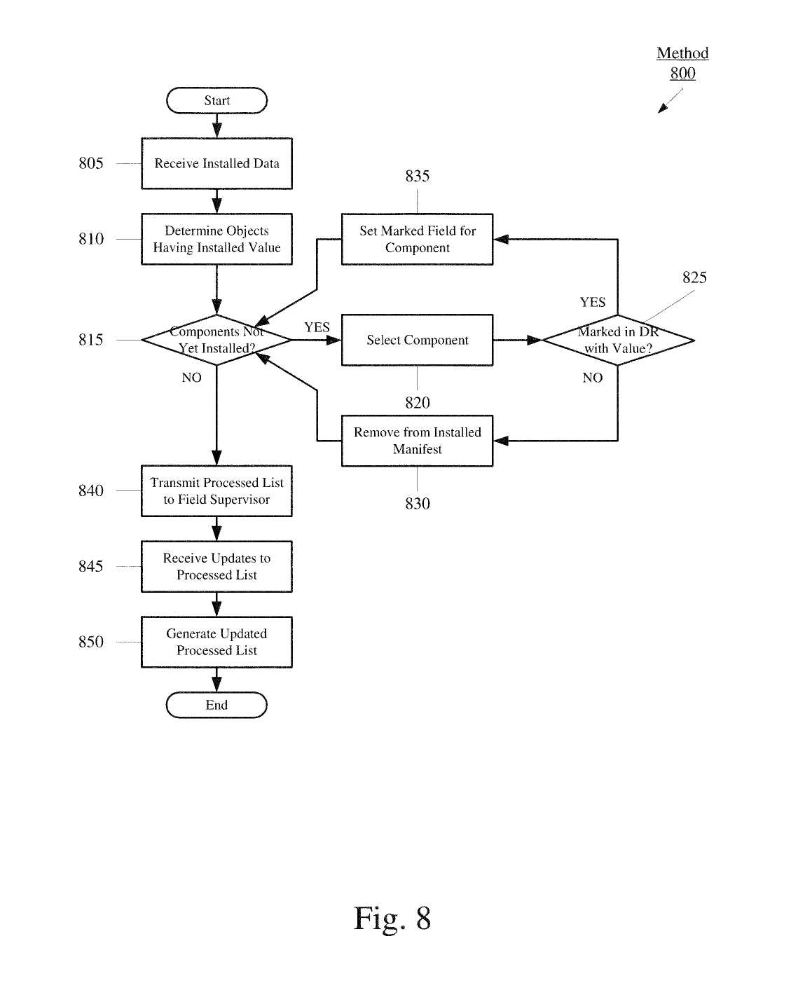

FIG. 8 shows a method 700 for tracking components that have been installed according to the exemplary embodiments. The method 800 in this exemplary embodiment relates particularly to the management application 220 of the server 105. Accordingly, the method 800 will be described with respect to the server 105. As will be described further below, the method 800 describes interaction between the field supervisor device 130 with the server 105 to manage and track components in a layout drawing that have been installed. The method 800 will be described with regard to the system 100 of FIG. 1.

In step 805, the server 105 receives the data corresponding to the installed components from the field supervisor device 130. As discussed above, the installed data may be received from the field supervisor device 130 once the progress application 335 has verified which components have been installed. Furthermore, as the exemplary embodiments provide a near-live visual representation, the server 105 may receive the installed data each time the field supervisor device 130 updates the status of a component to indicate that it has been installed. Alternatively, the server may receive the installed data at regularly scheduled time intervals or when the updated data is requested by any user.

In step 810, the server 105 identifies components that have values corresponding to “marked installed.” For example, this data may be input by a user by scanning a bar code or other marking on a component that identifies the component to the system and then by entering the new status (e.g., “marked installed) for that component. Those skilled in the art will understand that this method or any other known method may be used to identify a component to the system for a status update for any of the methods described herein. Components having this value are considered to have been installed and completed for the job. It is noted that the value determined for the method 800 may be a final role value as the installation of the component represents a third status analysis which may be altered if at any time the component status changes.

In step 815, the server 105 determines whether the installed data identify any components that have not yet been indicated as installed by a field engineer. It is again noted that any number of methods may be used to ensure the component's status values are properly understood by the server. As the method 800 relates to a continuous operation in completing the job, there may be components that were installed on entered on an installed manifest in a prior passthrough of the previous methods. Each time the status of various components is updated, the method 800 will update the list and remove any items that have been shipped.

If at least one newly installed component is identified, the server 105 continues the method 800 to step 820. In step 820, the server 105 selects this component and in step 825, the server 105 determines whether the selected component has a relevant value or mark (e.g., “marked installed”) with the appropriate user role in the data repository 110. If the selected component does not have the value/mark and the user role, the server 105 continues the method 800 to step 830 where a determination is made that the component is not yet installed. Accordingly, the component may be removed from an installed manifest at a job site. However, if the selected component has the proper value/mark and the user role, the server 105 continues the method 800 to step 835 where the marked field for the component is set.

Returning to step 815, when there are no further components to analyze, the server 105 continues the method 800 to step 840. In step 840, the server 105 generates an installed list that is transmitted to the field supervisor device 130. When the field supervisor device 130 receives the installed list, the progress application 335 displays the processed list to the field supervisor. This provides an opportunity to update the status for any components that require a change. For example, the field supervisor may determine that a further component may have been improperly installed and should be reinstalled. The field supervisor may thereby update items on the processed list if required. Thus, in step 845, the server 105 receives the updates to the installed list. Accordingly, in step 850, the server 105 generates the updated installed list for components that have been installed at the job site under the field supervisor.

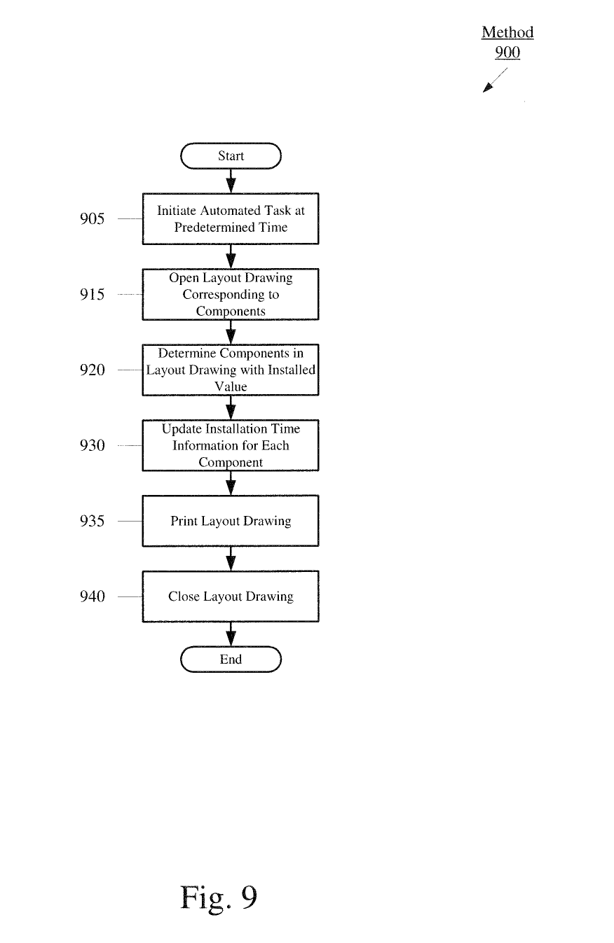

FIG. 9 shows a method 900 for updating a layout drawing where the drawings shows various components described above in regard to the exemplary embodiments. The method 900 will be described in relation to a system such as the system 100 running a management application such as the management application 220 on a server such as the server 105. As will be described further below, the method 900 facilitates interaction between the server 105, the data repository 110 and devices such as the executive device 135 to update information that may then be displayed in layout drawings reflecting the status of a job in real-time or near real time.

In step 905, the server 105 initiates an automated task at a predetermined time. As described above, the management application 220 performs an automated (or manually initiated) task to update the status of various components to be installed at a job and to display this updated information in a visual representation on, for example, a layout drawing. As would be understood by those skilled in the art, the update of the status information may be performed at a predetermined time (e.g., during overnight hours when there is little other demand for computing resources). Alternatively, the data may be updated immediately upon receipt of every update in the status of any component, after a predetermined number of components have had status updates, parts of the update may be processed on a schedule in off hours (e.g., portions of an update requiring more processing resources) while other parts are updated continuously or more frequently or the system may update upon a request for updated information from any user. The overnight updating scenario may be used when the progress of a job is generally to be viewed at the start of each day to determine what has been accomplished since the previous day and to make decisions going forward for the allocation of resources (e.g., fabrication, shipping and storage capacities). For example, if the visual representation of the layout drawing is viewed more frequently at a particular time during a working day, this visual representation may be updated so that, at this time, the latest data is displayed.

In step 915, the server 105 selects a layout drawing of a job including a plurality of components. Specifically, the server 105 may select an active layout drawing in which work is currently being performed to update status indicators. In step 920, the server 105 identifies all components in the layout drawing that have already been installed up to the current time. For example, the server 105 may perform the update once per day and determine that a component has been installed three days ago (relative to the current time). It is noted that each component having the installed indicator may have an associated timestamp defining the installation date and/or time. The timestamp may be an absolute timestamp value indicating the time at which the component was entered into the system as an installed component.

In step 930, the server 105 updates the installation times for the components in the layout drawing. Specifically, for components that have an installed value that indicates they were recently installed (after the previous update), the installation time for these components may be updated as within the last time frame from the previous predetermined time (e.g., within the last 24 hours). For components that have the installed value that indicates they have not been processed or were installed previously, the installation time for these components may be updated to add an additional time amount between predetermined times. For example, with the time amount between predetermined times being 24 hours, an unprocessed component that had previously been indicated as having been installed 6 days ago may have its installation time updated to 7 days ago. Once the installation time values for all components have been updated, in step 935, the server 105 prints the layout drawing such as printing the layout drawing to a predetermined or selected file format (e.g., pdf) for viewing by the executive device 135. In step 940, the server 105 closes the layout drawing.

It should be noted that the method 900 may include additional or modified steps. For example, the server 105 may include visual updates for the installation times in the layout drawing. For example, a color coding scheme may be used. The color coding scheme may change a color for an component based on an amount of time elapsed since the component status was changed to “marked installed.” Thus, for components that have been recently installed within one time period (e.g., within 24 hours), the component in the layout drawing may be changed to a first color (e.g., red). For components that have been installed within one week (e.g., 6 days ago), the component in the layout drawing may be changed to a second color (e.g., green). For components that have been installed more than one week ago, the component in the layout drawing may be changed to a third color (e.g., blue).

In another example, the method 900 may be modified for use with other status values. For example, the server 105 may also identify components that have been recently fabricated, received from vendors, prepared for shipping, have shipped, have been received at the job site, and have been installed. Any of these status values may also be represented in the layout drawing for review by the executive device 135 or other device that requests the visual representation of the layout drawing.

In a further example, the method 900 may utilize ephemeral data. Specifically, the ephemeral data may indicate components that have had a change. In a specific example, the server 105 may also track any component that has had a value change to “marked installed” representing a component that was installed within the previous 24 hour period (if the updating operation is performed once a day). Thus, the server 105 may identify the installed value change for recently installed components (e.g., within the time frame between this predetermined time and the immediately previous predetermined time).

It is noted that the layout drawing may also include further features or component information to be reviewed by the requesting device. For example, the components may include related information other than status such as part type, part numbers, part weight, part price, linear entry types, etc. In preparing the component information, the server 105 may provide the data necessary to create tables to visually represent the component information associated with a layout drawing for a job. For example, the components in the layout drawing may be ordered in the table with the price and weight information relative to the component, relative to the collection, and relative to the overall total.

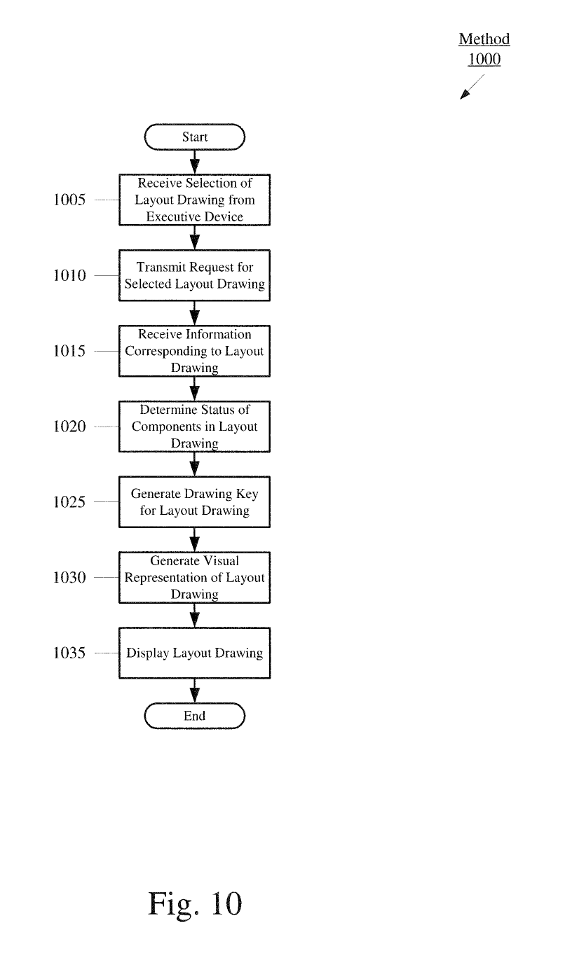

FIG. 10 shows a method 1000 for displaying drawings of components according to the exemplary embodiments. The method 1000 is related particularly to the progress application 335 of the executive device 135. Accordingly, the method 1100 will be described with respect to the executive device 135 utilized by an executive. As will be described further below, the method 1000 describes interaction between the server 105 and the data repository 110 with the executive device 135 to provide visual representations of the layout drawing for a job. Although the method 1000 is described with regard to the executive device 135, the exemplary embodiments may also display drawings of components to any requesting device. As discussed above, some users may require immediate status updates so that the server 105 provides real-time representations of the status of components in the layout drawings. Other uses may require summary status updates intermittently or on a schedule so that the server 105 provides an overall summary representation of statuses of components in the drawings to reflect changes since a previous update. The method 1000 will be described with regard to the system 100 of FIG. 1.

In step 1005, the executive device 135 receives a selection of a job and a layout drawing from the executive. As described above, the progress application 335 provides a menu of jobs. A selection of a job may also provide a submenu of layout drawings associated with the job. The executive may utilize, for example, the I/O device 320 to select the layout drawing. In step 1010, the executive device 135 transmits a request for the selected layout drawing to the server 105. Upon receipt, the server 105 may retrieve all related information corresponding to the selected layout drawing from the data repository 110. As described above, the related information may include status information of the components in the layout drawing and may also include further information. Once the server 105 has prepared the requested information, in step 1015, the server 105 receives the information.

In step 1020, the executive device 135 determines the status of components in the layout drawing. For example, components may still be unselected having no status information associated therewith. In another example, components may have been fabricated, received from vendors, prepared for shipping, shipped, received at a work site, or installed. In a further example, components may be distinguished by the different status states using a time characteristic to permit a user to distinguish between a component installed at a first time and a component installed at a second, different time even if the components are otherwise identical. In step 1030, the executive device 135 generates a drawing key to reflect the status of the components. In step 1035, the executive device 135 generates a visual representation of the layout drawing including the status information of the components and may include the drawing key which may be a legend for the user explaining the meaning of visual representation in terms of the status of the various components. In step 1040, the executive device 135 shows the visual representation such as on the display device 115.

It should be noted that the method 1000 may include further features such as generating other visual representations or appendices. For example, a table of other information or pop-up windows may be included for each of the components. The other information may include weight, pricing, type, manufacturer, etc.

It should further be noted that the visual representation and any associated tables may be created in a variety of locations. As described above, the server 105 may gather and process the data received from the devices 115-130. In a first example, the server 105 may create the visual representation and/or any tables and provide this data to a requesting device. In a second example, the requesting device such as the executive device 135 may receive the data from the server 105 and create the visual representation and/or any tables. In a third example, an intermediary device of the system 100 may receive the data from the server 105 and process requests for visual representations. In this manner, the server 105 may be reserved to only process the data.

The exemplary embodiments provide a device, system, and method to provide a visual representation of a status of components. The exemplary embodiments may track components of a layout drawing associated with a job. The exemplary embodiments may track various statuses of the components including when the components are either fabricated at a production facility or received from a vendor, when the components are available to be shipped, when the components have been shipped, when the components have been received at the work site, and when the components have been installed. The visual representation of the statuses of the components may be provided in a live manner and in a summary manner.

The exemplary embodiments provide an accurate representation the statuses which may be illustrated in a percentage completion for even the most complex of jobs. This representation enables more accurate and timely completion of the job but also for further features such as applications associated with payment and invoicing. This further provides aid in disputes over progress payments. Furthermore, all parties to a mechanics lien action are able to demonstrate the facts relevant to their respective case and assist a lien party with completing a response to a request for a verified statement of labor and materials.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a mobile device having an operating system such as iOS, Android, etc. In a further example, the exemplary embodiments of the above described method may be embodied as a program containing lines of code stored on a non-transitory computer readable storage medium that may be executed on a processor or microprocessor.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
receiving, by a central processing server, a layout drawing of an installation job, the layout drawing including a plurality of components that are to be installed at a work site;
receiving, by the server, status information of the components as a status of the components is updated;
dynamically updating, by the server, a current status for each of the components upon receiving the status information;
receiving, by the server, a request for a status update from a user device for a selected component of the components;
determining, by the server, the current status of the selected component; and
transmitting, by the server, the current status of the selected component to the user device.

2. The method of claim 1, wherein the status information includes at least one of a fabrication status, a received from vendor status, a prepared for shipping status, a shipped status, a received at job site status, and an installation status.

3. The method of claim 2, wherein the fabrication status indicates the components have been fabricated at a production facility managed by a shop foreman utilizing a shop foreman device, and wherein the received from vendor status indicates the components are received from a vendor.

4. The method of claim 3, wherein the fabrication status is generated by a production coordinator device utilized by a production coordinator and wherein the received from vendor status is generated by a vendor part coordinator device utilized by a vendor part coordinator.

5. The method of claim 4, further comprising:
receiving, by the production coordinator device, first components of the components that are to be fabricated at the production facility.

6. The method of claim 5, further comprising:
receiving, by the shop foreman device, first indications of the first components that have been fabricated,
wherein the first indications are included in the fabrication status.

7. The method of claim 4, further comprising:
receiving, by the vendor part coordinator device, second components of the components that are to be received from the vendor;
receiving, by the vendor part coordinator device, second indications of the second components that have been received,
wherein the second indications are included in the received from vendor status.

8. The method of claim 3, wherein the prepared for shipping and the shipped status are generated by the shop foreman device.

9. The method of claim 3, wherein the installation information is generated by a field supervisor device utilized by a field supervisor managing the work site.

10. The method of claim 1, wherein the components include previously installed components.

11. The method of claim 10, further comprising:
generating, by the server, a visual representation of the components in the layout drawing, the components including an installation indicator of when the installation of the components has been completed.

12. The method of claim 11, wherein the installation indicator is a color coding scheme.

13. The method of claim 11, wherein the user device is an executive device utilized by an executive.

14. The method of claim 11, wherein the visual representation is generated at a predetermined time as an automated task performed by the server.

15. The method of claim 11, wherein the visual representation is generated as a response to receiving the request.

16. The method of claim 1, wherein the layout drawing is a computer aided design (CAD) drawing.

17. A central processing server, comprising:
a transceiver receiving a layout drawing of an installation job, the layout drawing including a plurality of components that are installed at a work site and status information of the components as a status of the components is updated; and
a processor dynamically updating a current status for each of the components upon receiving the status information, the processor determining the current status of the selected component for a request of a status update from a user device for a selected component of the components,
wherein the transceiver transmits the current status of the selected component to the user device.

18. The central processing server of claim 17, wherein the job is a first job of a plurality of jobs managed by the server, and wherein the layout drawing is a first layout drawing of a plurality of layout drawings associated with the job.

19. The central processing server of claim 18, wherein the request includes a first identification of the first job and a second identification of the first layout drawing.

20. An executive device, comprising:
a transceiver transmitting a request for status updates of components associated with a first layout drawing, the request including a first identification of a first job among a plurality of jobs and a second identification of a first layout drawing among a plurality of layout drawings, the transceiver receiving a response including the status updates of the components;
a processor generating a visual representation including visual features indicating an installation time for each of the components based on the status updates, the visual representation further including a drawing key defining the visual features; and
a display device showing the visual representation.
